(19) United States
(12) Patent Application Publication
(10) Pub. No.: US 2004/0040432 A1
(43) Pub. Date: Mar. 4, 2004

(54) Intonation method and apparatus for stringed musical instrument

(76) Inventors: Gary D. Erickson, Fountain Valley, CA (US); Steven B. Wolff, Woodacre, CA (US)

Correspondence Address: Gary D. Erickson, 18303 Basswood St., Fountain Valley, CA, 92708, US

(21) Appl. No.: 10/367,274

(22) Filed: Feb. 14, 2003

Related U.S. Application Data
(60) Provisional application No. 60/356,592, filed on Feb. 14, 2002.

(51) Int. Cl. G10D 3/14

(52) U.S. Cl. 84/306

(57) ABSTRACT

A method and an apparatus provides for an optimum musical stringed instrument dynamic force chain comprised of simultaneous axial witness point adjustment mechanism, adjustable truss rod, high energy resilient and low friction tremolo bearing and mechanically optimized inline sensor structure.

The invention provides simple to achieve accurate intonation adjustment of a vibrating string in relationship to a fixed divisional pitch system which optimizing the instruments energy balance.

An inline vibration sensor is provided within the witness point structures whose mechanical impedance is tuned to provide optimum force chain admittance and is comprised of a piezoelectric composite or embedded within the entire instrument or various structural members.

An adjustable truss rod is provided to insure optimum curvature of the neck and fingerboard insuring intonation and stability.

A tremolo bearing comprised of hard and resilient material is provided under the tremolo pivot contact surfaces.

### CROSS REFERENCE TO RELATED APPLICATIONS

This is a continuation-in-part of the U.S. Pat. No. 5,986,190: String bearing and tremolo device method and apparatus for stringed musical instrument, which is hereby incorporated by reference.

We claim bit from the U.S. Provisional Application No. 60/356,592 filed Feb. 14, 2002.

### REFERENCES CITED

### U.S. PATENT DOCUMENTS

| D302563 | August 1989 | Sirmon et al. | |
|---|---|---|---|
| 2959085 | November 1960 | Porter | 84/314. |
| 4295404 | October 1981 | Smith. | |
| 4464970 | August 1984 | Mischakoff. | |
| 4541320 | September 1985 | Sciuto. | |
| 4696219 | September 1987 | Plescia | 84/314. |
| 4709612 | December 1987 | Wilkinson | 84/314. |
| 4742750 | May 1988 | Storey | 84/298. |
| 4768414 | September 1988 | Wheelwright | 84/307. |
| 4852450 | August 1989 | Novak. | |
| 4867031 | September 1989 | Fender. | |
| 5208410 | May 1993 | Foley | 84/298. |
| 5288344 | | Peker | |
| 5404783 | April 1995 | Feiten et al. | |
| 5481956 | January 1996 | LoJacono et al | 84/314. |
| 5600079 | February 1997 | Feiten et al. | |
| 5728956 | March 1998 | Feiten et al. | |
| 5750910 | May 1998 | LoJacono. | |
| 5932822 | August 1999 | Bernstein | 84/314. |
| 5955689 | | Feiten et al. | |
| 5986190 | November 1999 | Wolff, Erickson | 84/297R; 84/307; |
| | | | 84/313 |
| 6156962 | | Poort. | |
| 6188005 | February 2001 | White | 84/291. |
| 6429367 | | Fishman | |
| 6433264 | August 2002 | Gimpel | 84/314. |

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING APPENDIX

N/A

### BACKGROUND OF THE INVENTION

Axially Self Adjusting Witness Point

Mechanical Impedance Matching Inline Transducer

Adjustable Truss Rod

High Energy Resilient Tremolo Bearing

The present invention relates to the tuning of stringed musical instruments. More particularly, it relates to a tuning system comprised of intonation correcting witness points and elements of the dynamic force chain tuned to optimize the mechanical impedance and transducer sensitivity thereby affecting and improving sound quality.

Axially Self Adjusting Witness Point

The present invention is designed to optimize the string dynamics that are involved in the movement of the string over the two Witness Point devices. Current devises allow movement with only radial force present, due to a highly linear and high stiffness structure and have zero axial force present due to resistance and, or friction. The present invention is designed to allow the micro-displacement movements of the guitar neck/body movements and a vibrating string to move freely in both the axial and radial directions.

For years, inventors of string musical instruments have wrestled with the problem of properly designing an instrument that will play in tune to itself with proper intonation and thus be able to play in tune with other instruments. There is a difficulty with fretted string instruments because the fret placements are fixed and the string is stretched between 2 points, the bridge and nut. The string is said to be open or unchanged which we designate (Lopen). The open string in then pushed down with your finger against the string until it contacts a fret, which shortens the length of the remainder of the string producing an higher or raised pitch. The frets, being placed in a set pattern using a method called the rule of 18, are fixed in their positions so as to produce the next semitone higher according to the scale system of modern western music. In a perfect scaling system of frets the string would produce the correct semitone and all cross-string pitch relationships would stay in tune to each other. But in actuality, additional stresses are incurred which cause pitch shifts to take place. The string at Lopen is forced downward to meet the fret top which has the effect of stretching the string, which lengthens it, while increasing the strings tension and thus raising or sharpening the pitch beyond what is desirable.

In order for to compensate for this problem various devices have been constructed to allow for the pitch difference between open string and the fretted notes. This problem and the attempts at adjustment to the length of the string by intonation adjustment at the nut and or the bridge is not new and should be considered public domain. The earliest adjustments to modern guitars, at the nut, were done by a company in the sixties called Microfrets. Since then many inventors have experimented with new designs to compensate for the string stretch. LoJacono, patented a nut (U.S. Pat. No. 5,750,910 LoJacono) that looks very much like the Gibson patented Tune-o-matic Bridge, Buzz Feiten patented a method (U.S. Pat. No. 5,955,689) by which you add a little extra string length to the intonation adjustment at the bridge. After shortening the fingerboard, at it's nut end, he assigns a broad and very vague amount of required change to the string length adjustment at the bridge. Poort (U.S. Pat. No. 6,156,962) designed a new method to make an ever widening nut. All three alterations to the nut require a shortening of the fingerboard. Poort requires the shortening be done at an angle to the first fret to compensate for the larger diameter strings retaining less length to account for more stretch and greater pitch change. The string stretches downward under pressure from your finger but since the amount of stretch varies from instrument to instrument the adjustments required by these previous designs still create a cause for tuning concerns. It can be demonstrated that in the above described methods as with all previous methods, there is a failure to produce an exact methodology for adjusting the strings length versus height at the nut and bridge, therefore the correct methodology is still in question.

Since the implementation of adjusting the string's length is something that takes place during the design and construction of a stringed musical instrument, it would seem that a methodology to compensate for the differences in string stretch and string thickness is necessary and unique. No person to date has devised a methodology that correctly accounts for the pitch shift due to string stretch. It is the contention of this invention that a methodology and apparatus have been designed that will allow the group of all fretted stringed musical instruments to be adjusted in order to intonate correctly.

Many theories have centered around changing the length of a string by shortening or lengthening it in relationship to it's scale length. Any alteration thus far suggested to the rule of 18 used traditionally by stringed instrument makers to perform the calculations for the placement of the frets has proven to be vague and produced inconsistent results. The shortening of the fingerboard length at the nut end which in turn causes a shortening of the length of the nut to the first fret thereby requiring additional changes to the bridge saddles intonation adjustment inconsistent with the rule of 18 by adding additional percentages to the saddle adjustments has proven fruitless. The rule of 18 is based on the sound principles of the Pythagoras Theorem and does not need to be altered.

Mechanical Impedance Matching Inline Transducer

Any transducer inline to the dynamic force chain will affect the intonation and tonal quality of the instrument. Inline transducers include all those where the transducer structure is placed within the witness point structure. These include transducers from Fishman U.S. Pat. No. 6,429,367 among others. Many transducers place a piezoelectric sensor beneath the 6 string guitar bridge blade seated within its slot.

When the mechanical impedance of the inline transducer is too high or low the intonation reliability, sound quality and the charge or voltage sensitivity may be adversely affected.

Adjustable Truss Rod

This design provides for adjustments to the tension of a truss rod within a stringed musical instrument neck. The truss rod is made in several sections with provisions to be adjusted from the side of the neck at various points. The circular Truss rod sections have been machined a “V” shaped wedge. Provision is made for the “V” shaped end of the truss rod to be draw toward its sectional counterpart by onforming inserts on two sides of the truss rod a threaded screw passes through the inserts to draw them together. One section of the screw has reversed threads, as does its corresponding inserts, so as to provide a squeezing or tension in action against the individual ends' of the truss rod sections. This embodiment provides for adjustment perpendicular to the force of the truss rod within the musical instruments neck.

High Energy Resilient Tremolo Bearing

Many tremolos use a metal to metal surface bearing. The stick-slip nature of such a bearing within the dynamic force chain adversely affects the intonation reliability and sound quality.

General (from prev patent)

String dynamics are what provides for various degrees of sustain, harmonics & tone, tuning stability, and tremolo action and reaction. The problems with both of the nut witness point systems is that they do not fully provide an environment that supports the string/neck/body unitary structural combination with the proper support to optimize each of the aforementioned attributes. A major contributor to the diminishment of each of these attributes is the stick/slip action of a standard brass and bone type nut witness point. With this traditional design a V or U shaped grove is supplied to fit the individual diameter of each string, as well as that of it's relative vertical and horizontal position. However, the nature of the brass or bone material is that the string always presses its way into the material by it's axial movement and radial pressure. This is often desired by the usual thinking, and provides not only a solid radial force but, in the negative a large axial frictional force of the stick/slip kind. This force is easily overcome by the change in string tension due to tuning machine adjustment, but NOT by the micro-movements in the axial displacement component of the string motion during vibration. The nature of this type of frictional motion is highly non-linear and stochastic in nature. In addition, the nature of this type of force in combination with tuning peg problematic movement, versus intentional tuning adjustments, and knife edged and/or hook return spring based tremolo bridges, constitutes a serious departure from the structural support requirements of the ideal string dynamics as discussed herein.

Secondly tremolo design has been nearly exclusively based upon variations in metal to metal bearings or the knife edge pivot point and roller.

Our strong opinion, and the basis for part of the Sting Bearing invention, is that in order to optimize the string dynamics as previously discussed one must allow the string to move axially over the Witness Point with only radial force present. A highly linear and high stiffness structure must provide near zero axial force due to resistance or friction. This must occur for the micro-displacement movements caused by the combinatorial motion of the string and guitar neck/body movements. These motions are on the order of acoustic and flexural displacement axial motions present in a vibrating structure such as a guitar or other stringed instrument.

We should further point out that standard bone or brass type nuts with fixed cut string groove, require adequate down pressure of the strings into the nut grooves. These grooves are intentionally cut to provide very high grabbing friction from the sides of the nut's grooves to the strings. This friction can be overcome by tuning adjustments. These structures therefore impose a large axial friction force on the strings due to the micro-displacement movements of the strings during play, thus producing an additional undesirable and adverse affect on the string dynamics. Additionally such typical nuts provide low radial stiffness whose characteristics are not linear. Moreover, when a tremolo type bridge is used the normal axial forces imposed by the tremolo action on the strings cause a stick-slip friction response by the V groove and nut interface. This type of force dynamic has an additional adverse effect on the string dynamics.

The value of solving the problem of the nut witness point lies in improving the string dynamics which in turn allows the user to experience longer sustain, greater tone, more stable tone and phase decay, better feel, stable tuning, improved intonation accuracy, smoother tremolo action/reaction, and force feedback. Operational and mechanical improvements should include: no nut wrench or handle adjustments required, strings do not become plastically deformed (kinked), tuning adjustments are single step only, intonation adjustments are easier, no string tree guides should be required, and strings should not cut themselves deeper into the nut grooves with time. These improvements reduce maintenance cost as well.

The requirements for a novel solution to these problems should provide a basis that allow the dynamics of the strings and instrument structure combination to truly move freely in the axial direction while simultaneously transmitting the vibratory forces of the strings into the instrument without loss or distortion in the radial direction.

The ideal in an acoustic wave sense for a witness point and tremolo bridge is to allow the acoustic mechanical stress waves to pass through the tremolo structure without gross mechanical impedance changes and without resonant structures with resonant frequencies either in the band of interest or with transient responses much less than those of the neck and strings and the other major mechanical guitar components.

### BRIEF SUMMARY OF THE INVENTION

The deficiencies of the prior art are substantially over come by the intonation system according to the present invention, which includes a witness point self adjusting axial mechanism, an transducer inline to the witness point whose mechanical impedance has been tuned to those of its neighbors, an adjustable truss rod, and a tremolo bearing composed of a high resiliency material.

Axially Self Adjusting Witness Point

The self adjusting witness point in one embodiment uses a gear mechanism to compute the axial position from the changed height adjustment.

Mechanical Impedance Matching Inline Transducer

An inline transducer in one embodiment is constructed from a composite or laminate structure within the witness point structure where the composite's Modulus of Elasticity is chosen to create a mechanical impedance match to the neighbors in the dynamic force chain.

Adjustable Truss Rod

A truss rod is provided in a left and right piece with a wedge screw adjustment mechanism pulling them together.

High Energy Resilient Tremolo Bearing

A fulcrum tremolo bearing inserted between the tremolo friction plates and constructed from Ruby or other hard and high energy resiliency materials.

### BRIEF DESCRIPTION OF THE SEVERAL VIEWS OF THE DRAWINGS

Axially Self Adjusting Witness Point

Mechanical Impedance Matching Inline Transducer

Adjustable Truss Rod

High Energy Resilient Tremolo Bearing

FIG. 1 shows string bearing 14 supporting a stretched string 18. The gear teeth 78 are visible.

FIG. 2 shows the intonation correcting adjustable witness point 12 within the cylindrical height/length adjustment barrel 22 being adjusted via the worm screw 76 using a hex wrench inserted in the head of the worm screw.

In addition the horizontal adjustment is via the threaded intonation screw 124.

FIG. 2a shows a plurality of intonation correcting adjustable witness point 12 illustrating various height adjustments.

FIG. 3 shows the intonation correcting adjustable witness point 12 within the cylindrical height/length adjustment barrel 22, the worm screw 76 and the threaded intonation screw 124.

FIG. 4 shows an additional view of the intonation correcting adjustable witness point 12 and the notched cylinder or rod 20.

FIG. 5 shows 56 the assembly of horizontally, vertically, and axially adjustable string bearing bridge witness point.

FIG. 6 shows 74 inner bearing surface and 60 witness point element

FIG. 7 shows 72 outer bearing surface and 46 horizontal adjustment screw

FIG. 8 shows a side view 22 cylindrical height/length adjustment barrel supporting the 78 pinion shaft.

FIG. 9 shows a acoustic guitar bridge 54 with its 126 bridge saddle retaining slot.

FIG. 10 shows the that is to be inserted into the a acoustic guitar bridge 54 with its 126 bridge saddle retaining slot. A string is shown 18.

FIG. 11 shows 128 slotted bracket rectangular post for bridge retain slot. A pluarility of the adjustable string bearing assemblies 102 are mounted using the 98 mounting apparatus.

FIG. 12 shows an additional view of the adjustable string bearing assembly 102.

FIG. 13 shows the string 18 curling through the adjustable string bearing assembly 102 and the 62 string termination ball end is terminated in the 64 wedge tightening bridge pin.

FIG. 13a shows a schematic illustration of the string bearing assemblies 102.

FIG. 14 shows additional views of the adjustable string bearing assembly 102 installed into an acoustic guitar bridge.

FIG. 14a shows additional views of the adjustable string bearing assembly 102 installed into an acoustic guitar bridge.

FIG. 15 shows additional views of the adjustable string bearing assembly 102 installed into an acoustic guitar bridge.

FIG. 16 shows additional views of the adjustable string bearing assembly 102 installed into an acoustic guitar bridge.

FIG. 17 shows 130 Nut assembly on a guitar nut on the 132 Neck base.

FIG. 17a shows a plurality of the adjustable nut 130 assemblies.

FIG. 18 shows the 136 Ring bearing.

FIG. 18a shows the side view of the adjustable nut 130.

FIG. 19 shows an cam adjustable nut with its 147 String Bearing surface for string.

FIG. 20 shows the cam adjustable nut cross-section with the 149 Threaded screw for cam riser and the 150 Cam riser rod.

FIG. 21 shows an alternative 150 Cam riser rod cross-section.

FIG. 22 shows the adjustable truss rod and the various 153 arc apex and the 154 resultant gaps between the Upper and Lower Rods.

FIG. 23a-d shows Sectional Truss rod 165 wit the 160 Right hand Threaded Wedge Rod or insert with ball grips.

FIG. 24 shows with wedge grips.

FIG. 25 shows an alternative wedge grip.

FIG. 26 shows the 167 Tremolo Block with Tremolo bearings 171 low friction material.

FIG. 27 shows a cylindrical embodiment of the inline transducer with the 183 PZT material adhered to polymer tube on opposing sides or covering entire circumference and its electrical connector 181 micro 5 pin din plug.

FIG. 28 shows a planar embodiment of the inline transducer where the 193 Piezo material Is folded into the 192 polymer film sheet bent into “S” shape after printing trace.

FIG. 28b shows a planar embodiment of the inline transducer where the polymer sheet is a single layer.

FIG. 29 shows the inline transducer within the neck interface of the 168 Musical instrument body.

FIG. 29b shows a detailed view of the laminated vertical 193 Piezo material.

FIG. 30 shows a detailed view of the layers of 199 layer of Piezo fiber wrapped around the 200 Positive circuit trace and the 203 Polymer tube.

### REFERENCE NUMERALS IN DRAWINGS

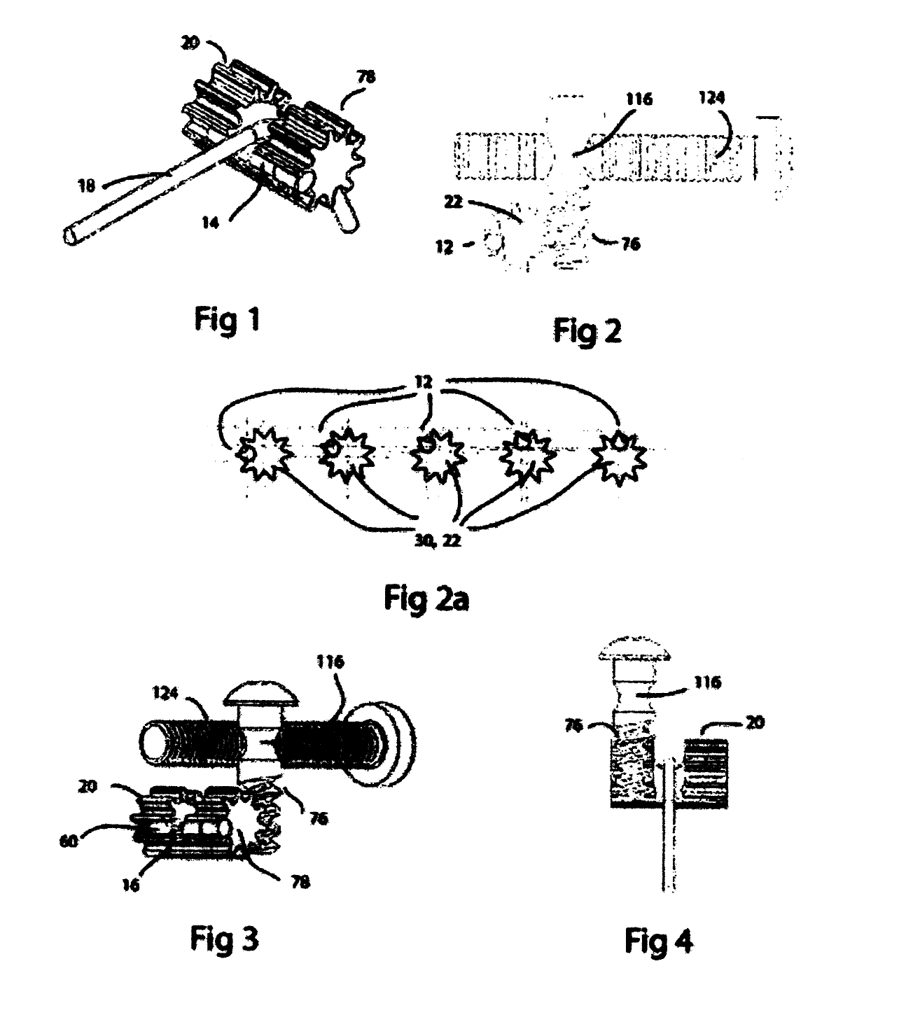

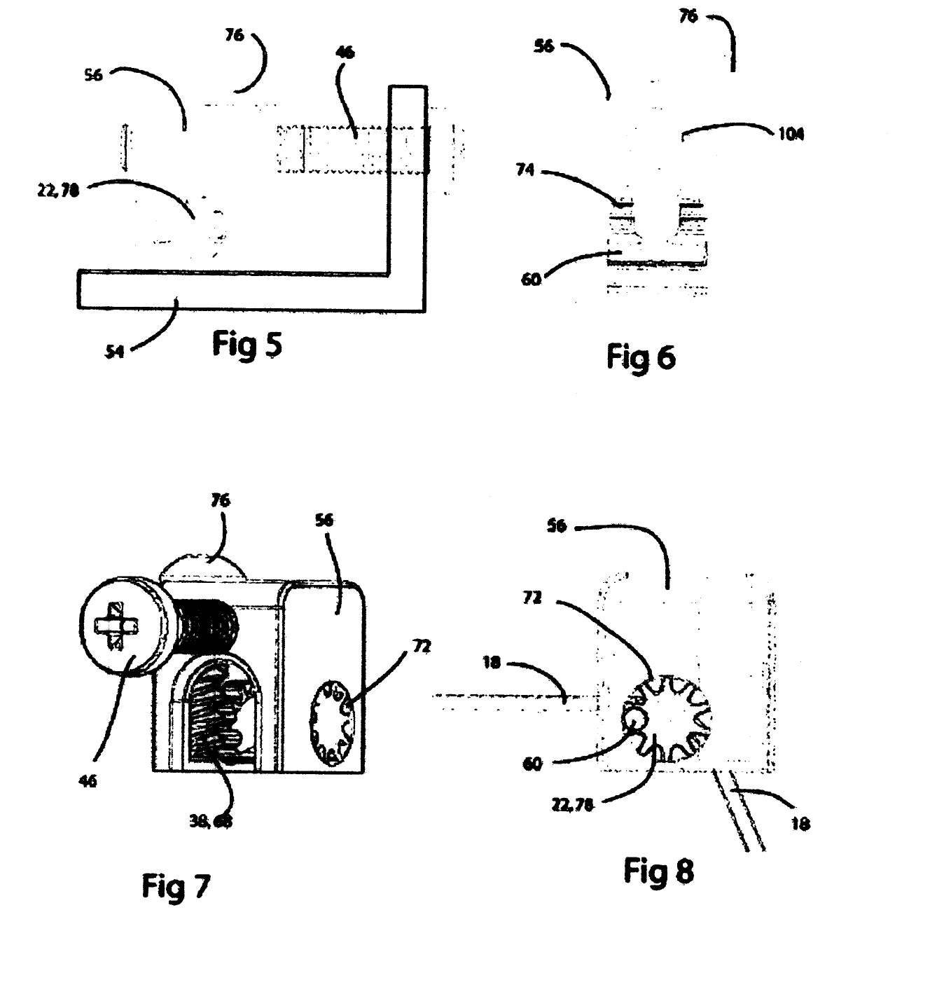

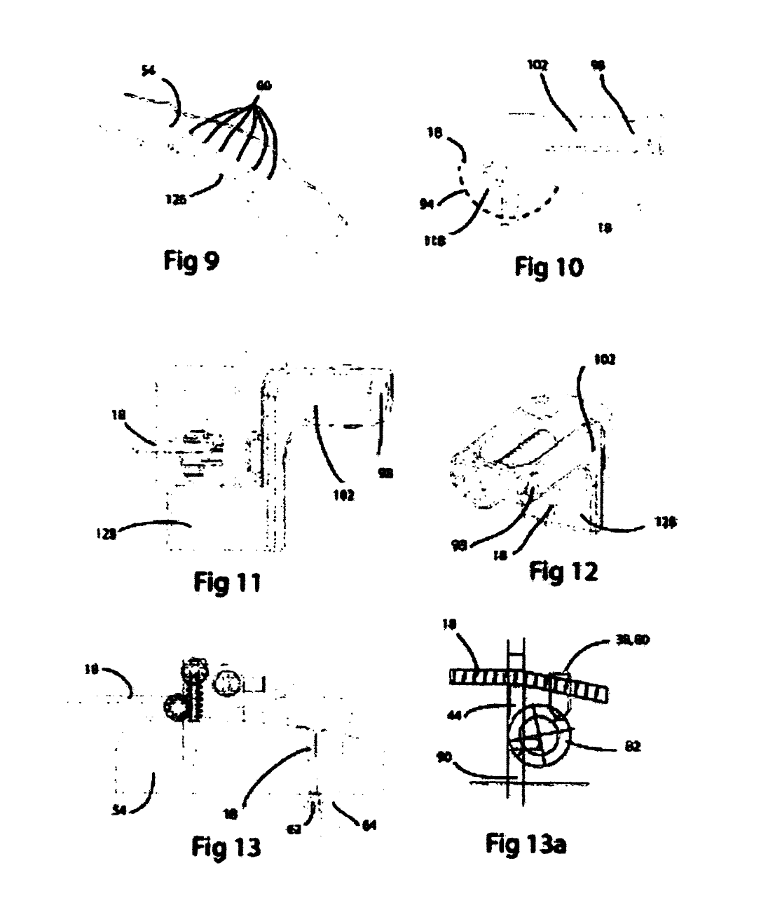

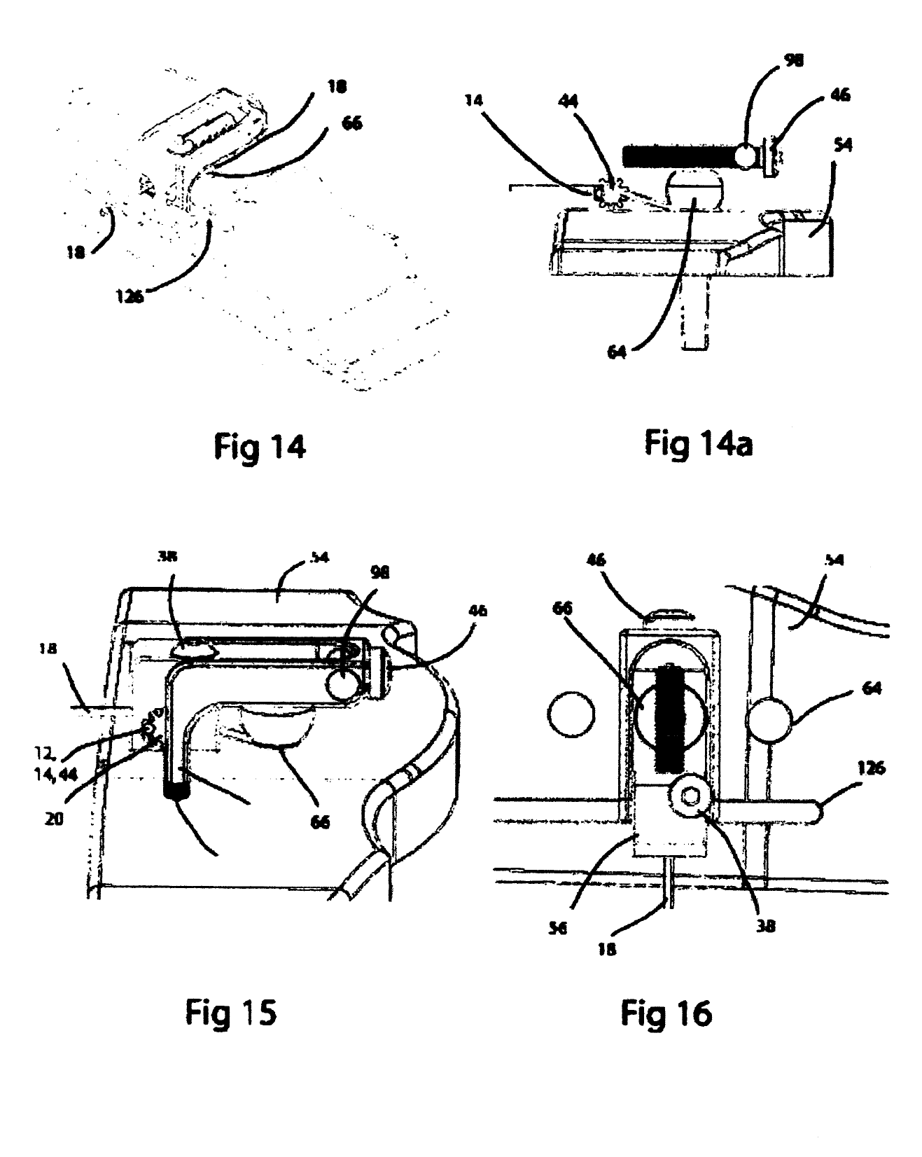

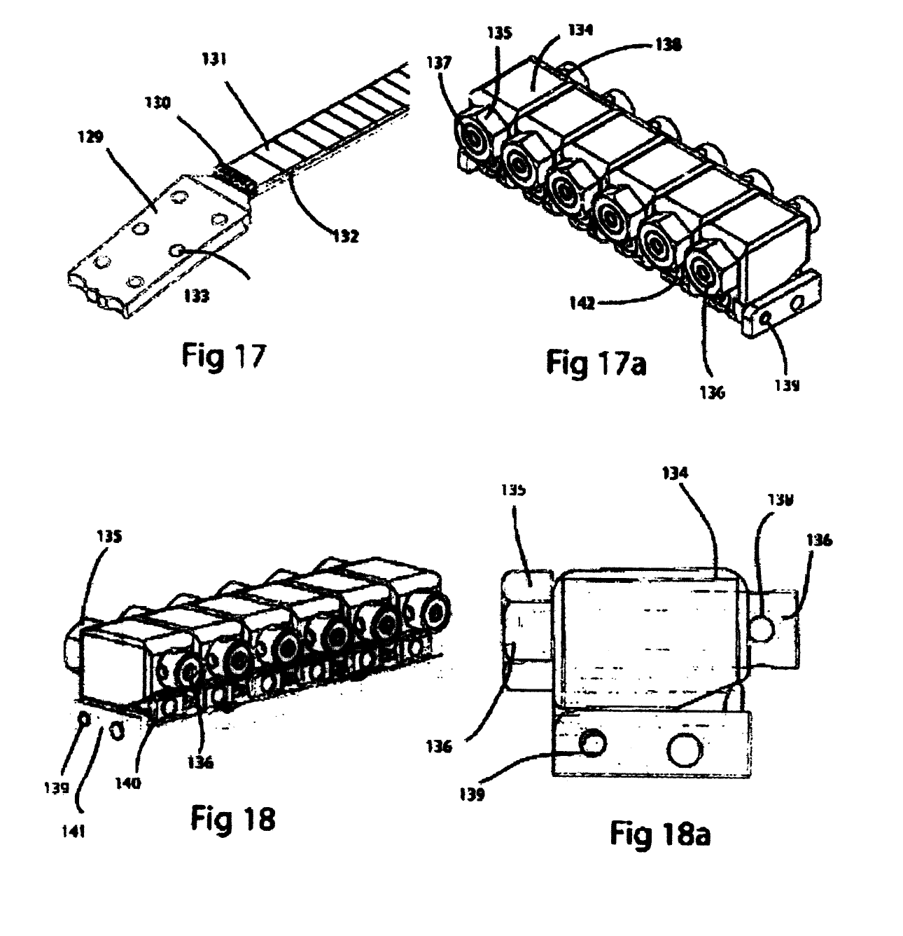

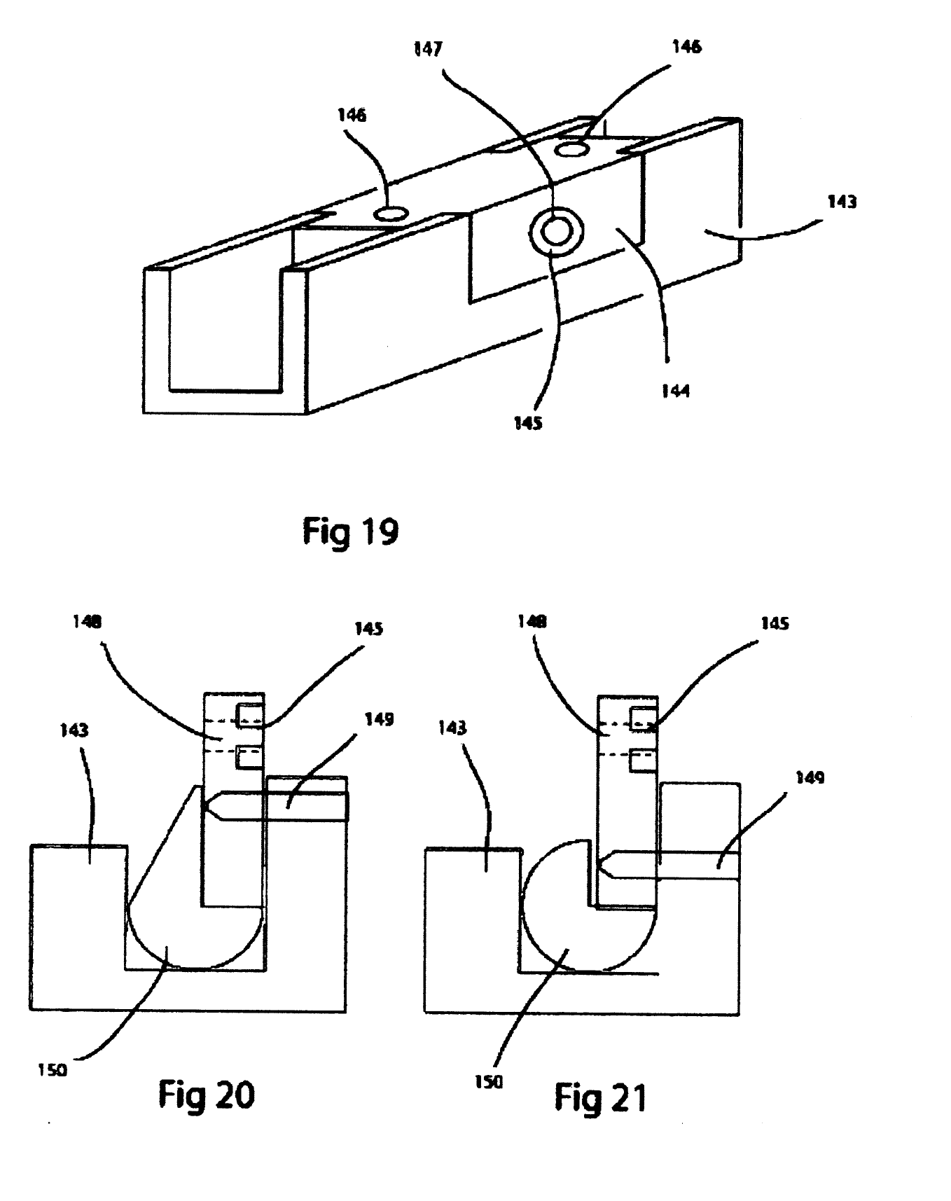

FIGS. 1 to 21

12 intonation correcting adjustable witness point

14 manually height adjustable string bearing

16 v-notch in nut witness point element

18 string

20 notched cylinder or rod

22 cylindrical height/length adjustment barrel

24 witness point

26 bridge witness point element

28 v-notch in bridge witness point element

30 adjustable witness point

32 assembly of horizontally, vertically, and axially adjustable string bearing nut witness point

34 base plate

36 saddle with adjustment

38 height or vertical adjustment screw

40 string bearing inserts front and back on each saddle

42 high hardness string bearing fret

44 adjustable string bearing bridge witness point riser saddle

46 horizontal adjustment screw

48 axial adjustment screw

52 bridge string bearing inserts front and back per saddle

54 bridge base plate

56 assembly of horizontally, vertically, and axially adjustable string bearing bridge witness point

58 high hardness finger board string bearing

60 witness point element

62 string termination ball end

64 wedge tightening bridge pin

66 bridge pin hole for string termination

68 worm gear threads

70 string termination points

72 outer bearing surface

74 inner bearing surface

76 worm screw

78 pinion shaft

80 set screw

82 rotational control cylindrical height/length adjuster

84 cylindrical height/length adjuster

88 longitudinally cut rod

90 plate

92 post in the center diameter

94 acute break angle

96 additional intonation apparatus

98 mounting apparatus

100 adjustment barrel

102 slotted bracket

104 retaining hole

106 adjustment screw

108 bottom bearing surface

110 solid base plate

112 bearing surfaced cylindrical ring

114 hex head barrel screw

116 bearing surface

118 threaded nut saddle

120 tie rod

122 pivot

124 threaded intonation screw

126 bridge saddle retaining slot

128 slotted bracket rectangular post for bridge retain slot

129 Head stock

130 Nut assembly

131 Fingerboard

132 Neck base

133 Receptacle hole for mechanical string tensioner

134 Nut saddle

135 Tubular hex screw

136 Ring bearing

137 String bearing surface

138 Adjustment Hole

139 Tie Rod

140 wedge block for height Adjustment

141 Adjustable nut mounting base

142 Tension screw for wedge block

143 nut base channel

144 Nut saddle riser block

145 Ring bearing

146 Threaded hole for height adjustment

147 Bearing surface for string

148 String hole

149 Threaded screw for can riser

150 Cam riser rod

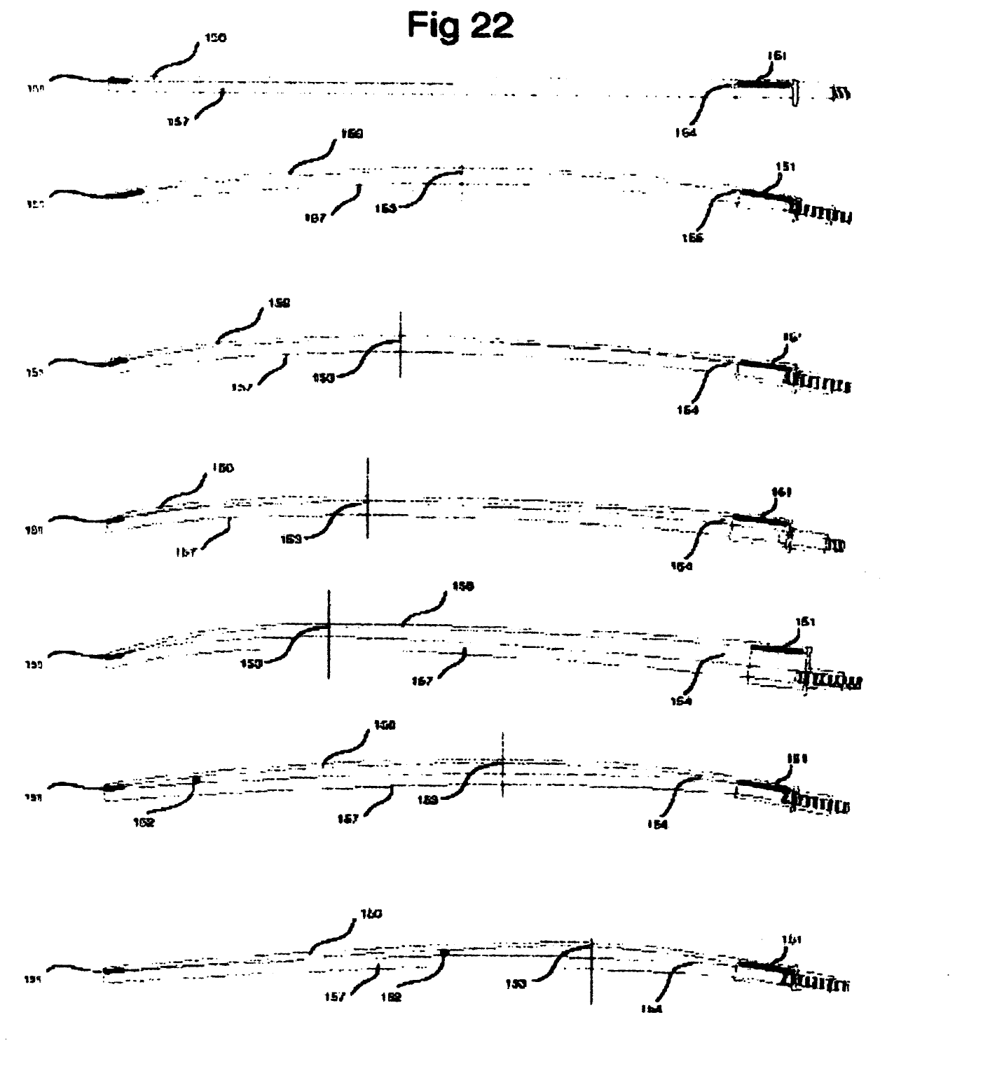

FIG. 22

151 Rods are Welded Together at this point

152 Truss Rod Wedge Block

153 Arc Apex

154 Resultant between Upper and Lower Rods

155 No Resultant Gap between Upper and Lower Rods

156 Upper truss rod

157 Lower Truss rod

151 Rods are Welded Together at this point

152 Truss Rod Wedge Block

153 Arc Apex

154 Resultant between Upper and Lower Rods

155 No Resultant Gap between Upper and Lower Rods

156 Upper truss rod

157 Lower Truss rod

158 Upper section of Truss Rod

159 Low section of Truss Rod

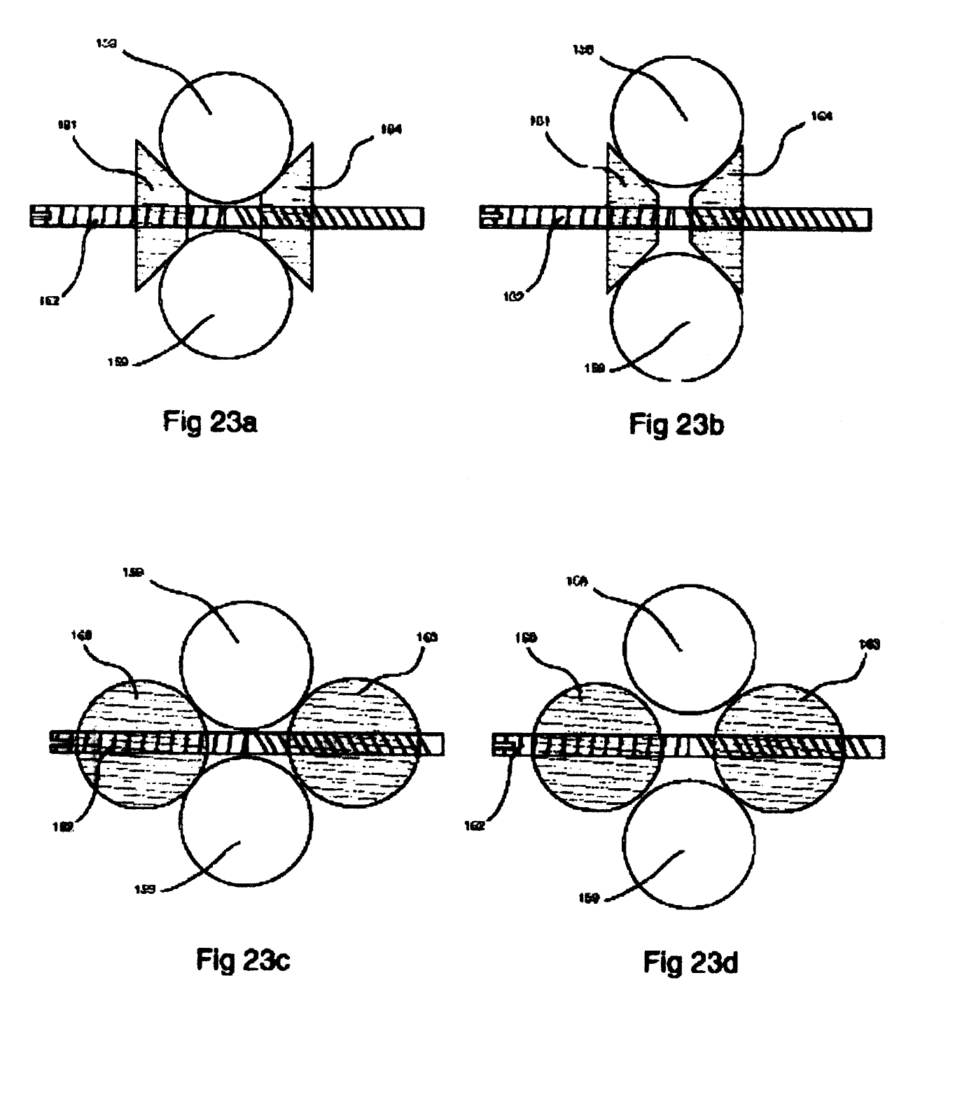

FIGS. 23-25

160 Right hand Threaded Wedge Rod or insert

161 Right hand Threaded Wedge Block or insert

162 Screw with both right hand and left hand treads

163 Left hand threaded Wedge Rod or insert

164 Left hand Threaded Wedge Block or insert

165 Sectional Truss Rod

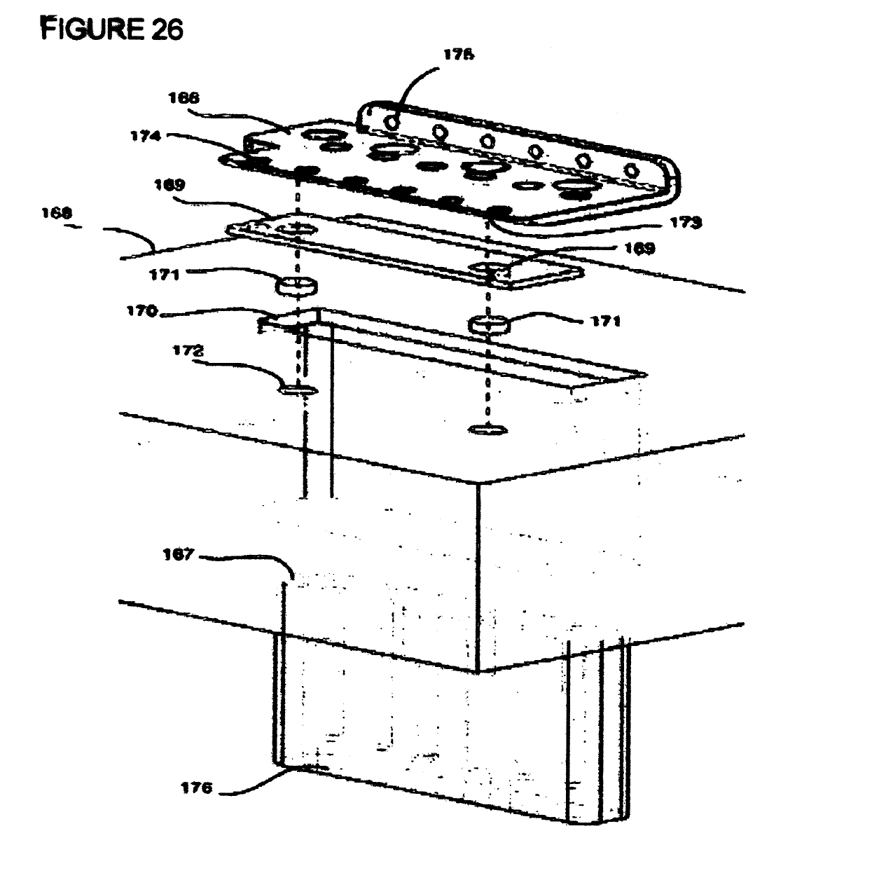

FIG. 26

166 Tremolo face plate

167 Tremolo Block

168 Musical instrument body

169 Tremolo face plate to body interface plate

170 Tremolo Block Receptacle Cavity

171 low friction material

172 Pivot point on body surface surface

173 Pivot point on tremolo plate surface

174 Anchor screw holes

175 Intonation screw holes

176 String retainer holes

180 NA—

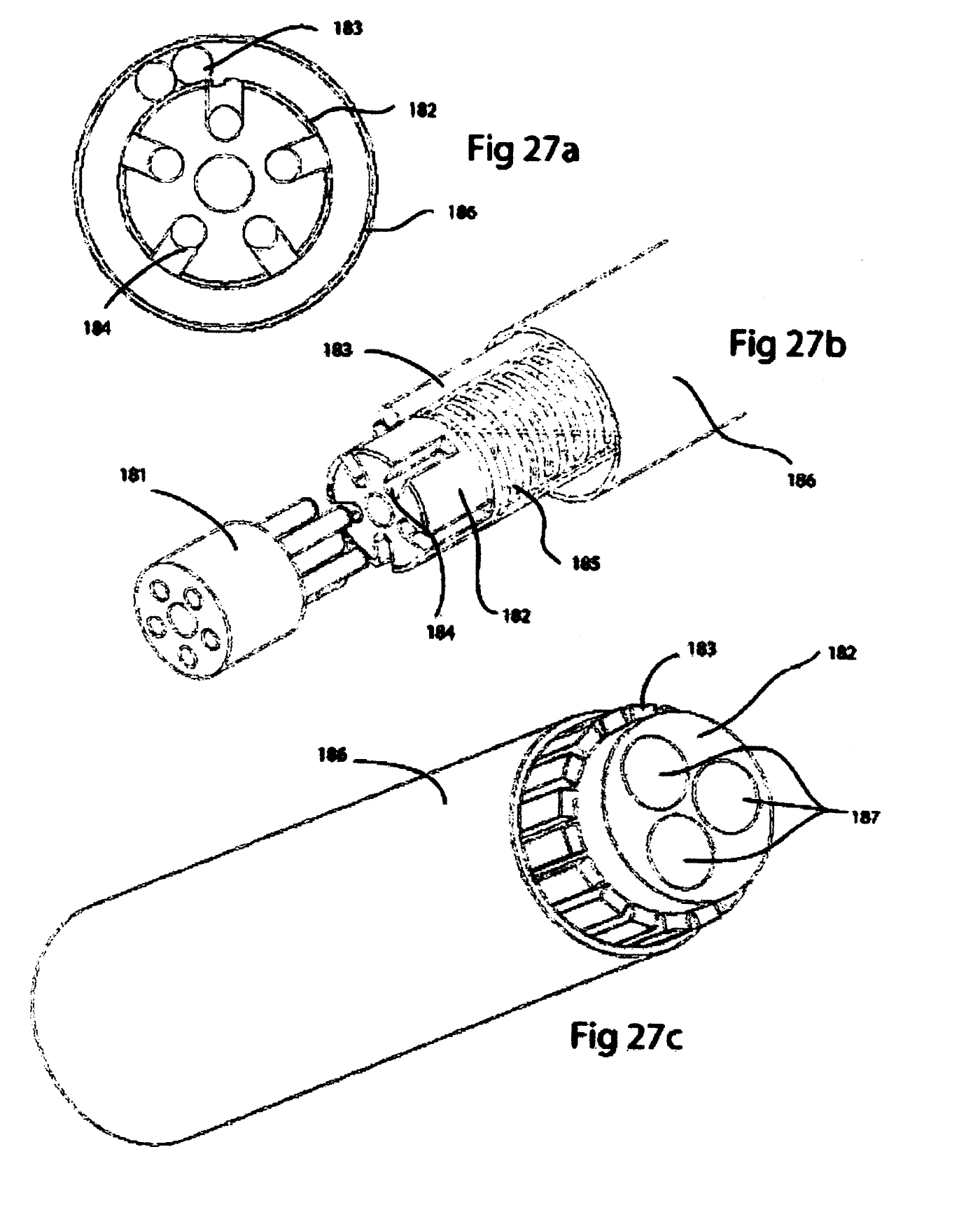

FIG. 27

181 micro 5 pin din plug

182 polymer 5 hole tube

183 PZT material adhered to polymer tube on opposing sides or covering entire circumference

184 notches coated with conductive ink

185 conductive ink printed in electronic trace pattern

186 shielding material sleeve

187 Longitudinal lumen holes

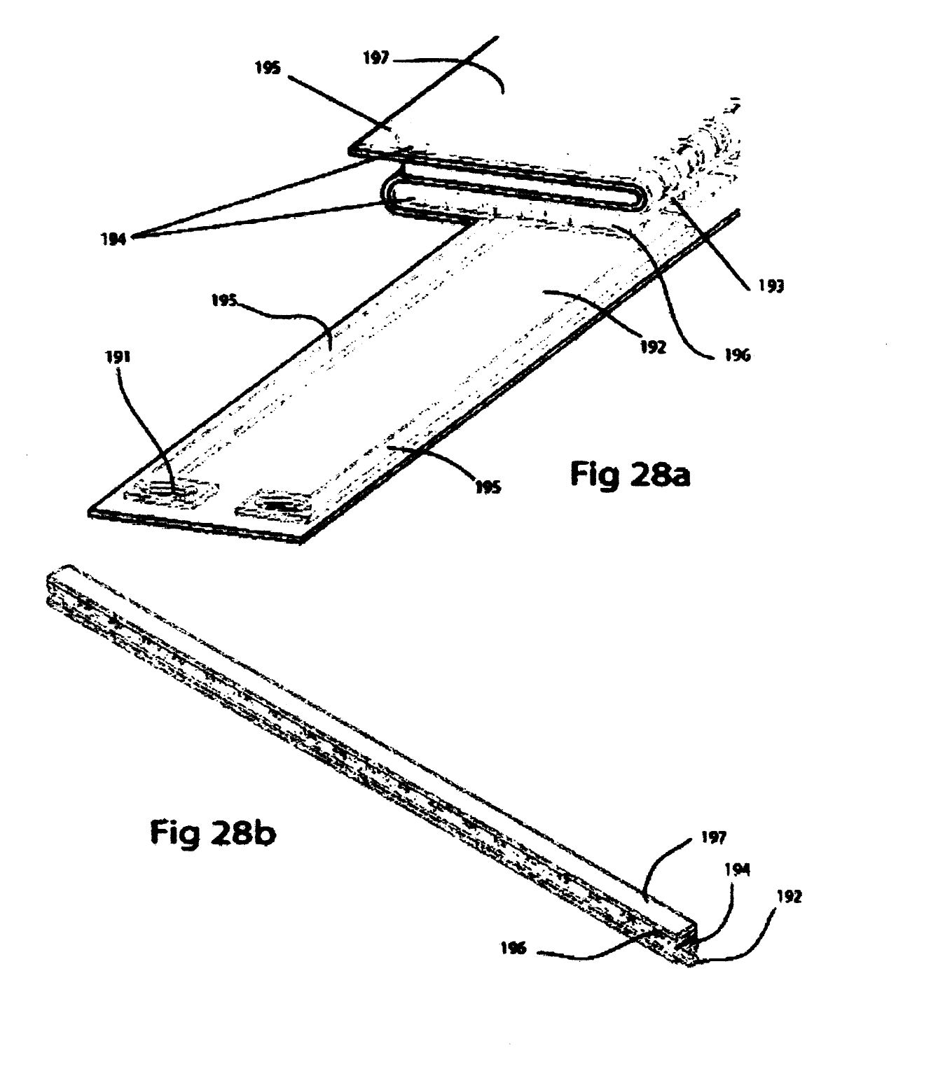

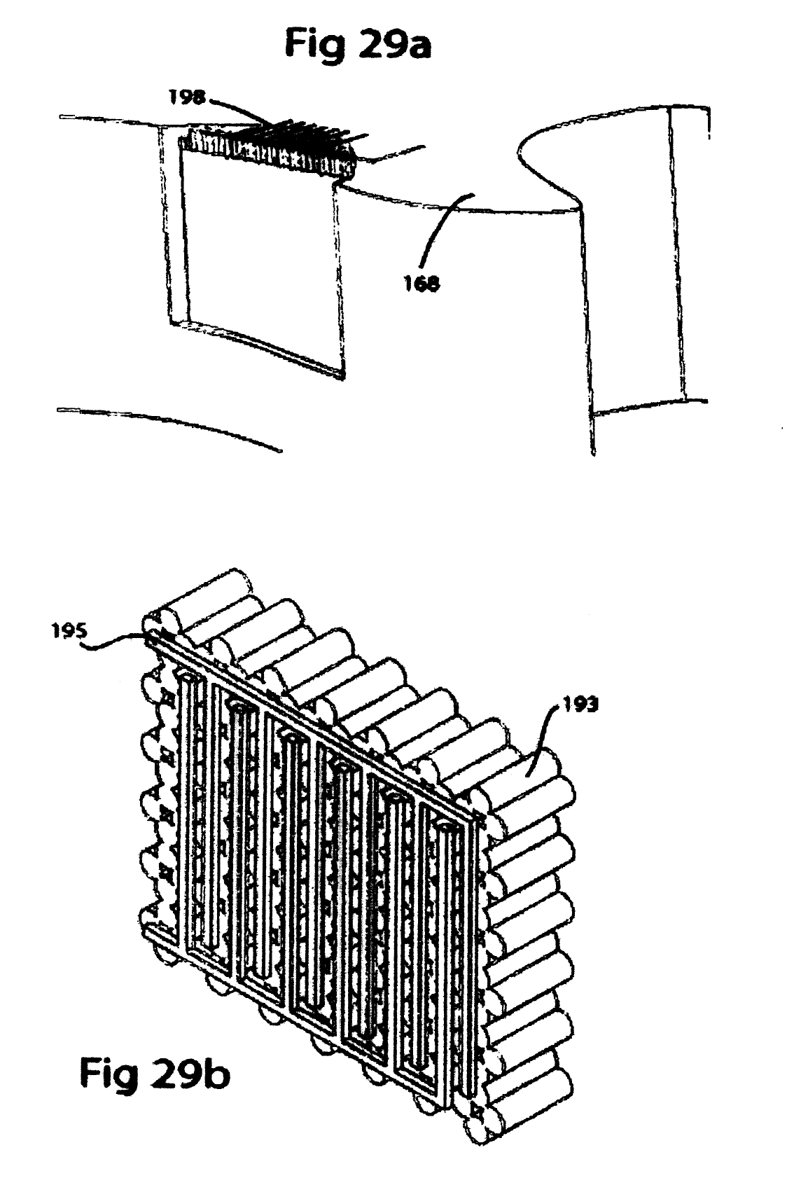

FIGS. 28-29

191 Conductive gromet holes for wire connection

192 polymer film sheet bent into “S” shape after printing trace

193 Piezo material

194 plastic or insert for pressure

195 conductive ink printed in electronic trace pattern

196 Piezo material adhered to polymer film and the traces on the film sheet

197 polymer film

198 horizontal electrodes

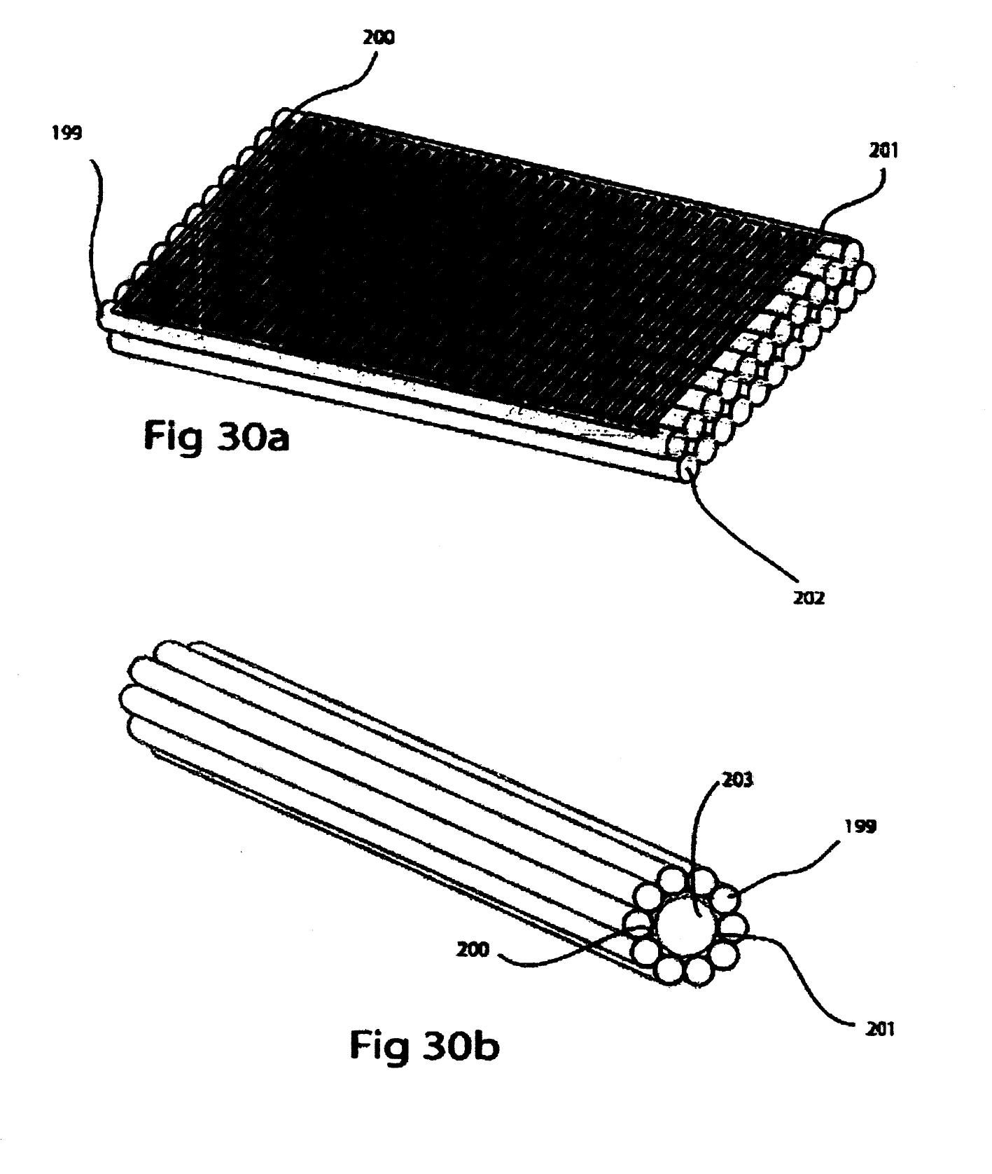

FIG. 30

199 layer of Piezo fiber

200 Positive circuit trace

201 Negative circuit trace

202 layer of Piezo fiber

203 Polymer tube

### DETAILED DESCRIPTION OF THE INVENTION

Axially Self Adjusting Witness Point

Mechanical Impedance Matching Inline Transducer

Adjustable Truss Rod

High Energy Resilient Tremolo Bearing

Axially Self Adjusting Witness Point

Describe Invention

Proper intonation of any string during play requires that the fretted pitch must be in tune within 10 cents of frequency. Typically the string gains additional tension when fretted. This extra tension during fretting can be offset by adjusting the axial position of the nut witness point. The axial displacement can be calculated for each height adjustment using mechanical or computational means.

The preferred embodiment of the invention to perform the calculation is to use a worm and spline gearing mechanism.

Prove of the Invention by Calculation

Background Question

One would think that if the fretted (Lbridge_f12) string length ratio is ½ of the open string (Lopen) then the frequency ratio would be exactly 2.0 and therefore pitch perfect (Ffret_f12) but the reality is that the extra stretch due to the fretting of the string pulls the fretted string frequency away from this ideal goal of 2.0 of the open string frequency [Fopen].

Achieving the perfect pitch when a sting is fretted is the goal of the invention and we intend to prove this via the calculations that follow.

We have derived equations that show that the Axially Self Adjusting Witness Point apparatus and methods do insure that a string can be in-tune for both its open pitch but also for its fretted pitch if the length of the open string (Nut to Bridge witness point length, herein referred to as Lopen) is shortened for a particular raising of the height of the nut.

Formulas and Theory for String Instrument Intonation Adjustments

We have derived equations that show that our apparatus and methods do insure that a string can be in-tune for both its open pitch but also for its fretted pitch if the length of the open string (Nut to Bridge witness point length, herein referred to as Lopen) is shortened for a particular raising of the height of the nut. This must follow a specific function in order to achieve this goal.

Conclusion:

$$Conclusion \text{:} \\ \frac{Ffret\_f12}{Fopen} = \frac{Lopen \cdot \{ Stretch due to fretting + Stretch of open tuned string \}}{Lbridge\_f12 \cdot \{ Stretch of open tuned string \} }$$

One can examine the included spreadsheets to see that this has been demonstrated.

The calculations are broken up into 3 areas:

1. Effect of shortening Lopen with increasing Fretted string stretch.

2. Effect of raising Nut height without the shortening of the Lopen.

3. Effect of raising Nut height with the shortening of the Lopen.

In each area one can see that certain combinations lead to a negative pitch ratio (in cents) indicating a flattening of the note.

The goal here is to prove that when one raises the nuts height one must shorten the open length of the string in order to achive perfect tune. This has been demonstrated by our calculations.

Therefore we contend that our apparatus and methods achieve the stated objects of the invention in a way that is superior to all prior art.

String and Nut Witness Point Physics Derivation

Frequency Equation and Parameters

A strings frequency is

f={1/(2·L})·√(T·G/M)

L is the witness length

T is the tensions

A strings Tension is:

T=Acore·E·Lstretch/Ltotal

M=AWaverage·B

The parameters are:

M Mass per unit length of the string (can weigh 1 cm and get X grams)

fcore cross sectional Area of string's core (element of stiffness)

AWaverage the area of the Average Winding

E modulus of Elasticity for the string material

D Density of string including windings if present

G Gravitational constant.

Basic Formula

Assumptions:

None

Pitch Formula for any string.

Frequency=Kstring·[1/Lopen]·√[Lstretch_open/Listat]

Frequency

Resultant pitch of the string (Hz or Radians per second)

Kstring=5·√{force·E·G/M}

It is the constant multiplier of a string's internal force (Tension) and weight (Mass) due to its stretch (due to tuning) resulting in an open string frequency.

It is the constant value that is an expression of the forces that must be exerted on a string to bring it to a desired pitch with regards to its modulus of elasticity, density, and tension and that this is a constant value for all strings of similar physical properties.

Ltotal

The total length of the string from the Tuner to the Tail piece terminations.

Specific Formula

To determine the affect on the pitch (frequency) by the geometry especially the nut geometry

Assumptions:

The Luthier always tunes the open string to the target pitch (Fopen) after any nut, bridge or string changes before measuring the accuracy of the fretted string's pitch (Ffret12) for example.

No assumptions are required for the geometry because it is general.

Fretting beyond the 0% level can be handled.

Neck 3D geometry and real neck bending can also be handled.

Scope:

These formulas are exact and give a good general idea of the requirements but are VERY dependent on the specific geometry such as changes in Lopen, Lstretch_open.

This requires knowing the exact geometry for valid calculations.

Ltotal

The total length of the string from the Tuner to the Tail piece terminations.

Lopen

The witness length from Nut center to Bridge center.

It is a ruler length, stretch is not relevant here.

Lfreted_fx

The witness length from Nut center to Fret center.

It is a ruler length, stretch is not relevant here.

Lbridge_fx

The witness length from Fret X center to Bridge center.

It is a ruler length, stretch is not relevant here.

Lstretch_open

Stretch of the open tuned string.

This is the additional length due to the stretching of the string to reach the open strings desired frequency.

This is not a ruler measurement.

Lfreted_fx+Lbridge_fx−Lopen

Stretch due to fretting string

This is the additional length due to the stretching of the string to reach the fretted strings desired frequency and it is added to the open string's stretch. This is not a ruler measurement.

Lfreted_fx+Lbridge_fx=Lopen+Lstretch_open

Stretch due to fretting string+Stretch of open tuned string

Open String Frequency Due to Stretch of Open String (Tuned)

Fopen=Kstring·[1/Lopen]·√[Lstretch_open/Ltotal]

Stretch of open tuned string

Fretted String Frequency due to Fretting of the String Down to Fret X

Ffret_fx=Kstring·[1/Lbridge_fx]·√[{Lfreted_fx+Lbridge_fx−Lopen+Lstretch_open}/Ltotal

Stretch due to fretting string+Stretch of open tuned string

We can eliminate the physical string parameters if we work with a ratios from the Fopen frequency to the target frequency Ffret_fx.

Ffret_f12/Fopen=2.0

An octave is the correct ratio for our target.

Ffret_f12/Fopen=

$$Ffret\_f12 = \frac{Kstring \cdot ( 1 / Lbridge\_fx ) \cdot [ \{ Lfreted\_fx + Lbridge\_fx - Lopen + Lstretch\_open \} / Ltotal ] /}{Kstring \cdot [ 1 / Lopen ] \cdot [ Lstretch\_open / Ltotal ]}$$

We can eliminate Kstring and Ltotal and thereby resolves down to:

Ffret_f12/Fopen=

$$Ffret\_f12 / Fopen = \frac{[ 1 / Lbridge\_fx ] \cdot [ \{ Lfreted\_fx + Lbridge\_fx - Lopen + Lstretch\_open \} ]}{[ 1 / Lopen ] \cdot [ Lstretch\_open ]}$$

Or:

$$Or \text{:} \\ \frac{Ffret\_f12}{Fopen} \begin{matrix}= \\ =\end{matrix} \frac{Lopen \cdot [ \{ Lfreted\_fx + Lbridge\_fx - Lopen + Lstretch\_open \}}{Lbridge\_f12 \cdot \{ Lstretch\_open \} }$$

Which is:

$$Which is \text{:}$$

$$\frac{Ffret\_f12}{Fopen} \begin{matrix}= \\ =\end{matrix} \frac{Lopen \cdot \{ Stretch due to fretting + Stretch of open tuned string \}}{Lbridge\_f12 \cdot \{ Stretch of open tuned string \} }$$

One would think that if the F ratio is 2.0 then the L ratio would be 1/2.0 but the reality is that the extra stretch due to the fretting of the string pulls the fretted frequency away from this goal.

One can offset this by using a shorter Lopen.

When changing the Nut Height Knut and/or X distance Knut then Lopen and Lfreted_f12 will also change. The only way to “flatten” the freq ratio is to reduce Lopen because the other terms only increase it although−Lfreted_f12 will also reduce.

Reduce Lopen by the inversion of:

$$Reduce Lopen by the inversion of \text{:}$$

$$\frac{ \{ Stretch due to fretting + Stretch of open tuned string \}}{ \{ Stretch of open tuned string \} }$$

therefore multiply Lopen by:

$$therefore multiply Lopen by \text{:}$$

$$Lopen \cdot \frac{ \{ Stretch of open tuned string \} }{ \{ Stretch due to fretting + Stretch of open tuned string \}}$$

to approximately return the fretted frequency back down to the target frequency.

Approximately because the Stretch due to fretting term contains elements affecting Lopen.

Still this gives us an approximation of the required and proper procedure to correct for string pitch “sharpening” when fretted.

Example Calculation to Determine the Compesating Axial Witness point dimension to
achieve the Correct Pitch as defined as close to zero Cents frequency difference

| Effest of | | | | | |
|---|---|---|---|---|---|
| shortening | | | | | |
| Lopen with | | | | | |
| Increasing | 0 Cents | | | | |
| Fretted string | Off is the | No height change Is for Illustration | | | |
| stretch. | goal | purposes | | | |
| O | CentsPitch | | | | |
| KFret_f12/Fopen | Change | Hnut | Lbridge_f12 tring | Sfretings | Sopenstring |

| | | | | | |
|---|---|---|---|---|---|
| Pitch Ratio | Cents Off | Lopen | XnutChange | Change | Fret Stretch Parameter |

| | | | | | | | | | |
|---|---|---|---|---|---|---|---|---|---|
| ✓ | 2.000079565 | 0.07 | 25.4375 | 0 | 0 | 12.75 | 0.005 | 1 | |
| | 1.997131045 | 2.49 | 25.4 | 0.0375 | | 12.75 | 0.005 | 1 | |
| | 1.969268324 | −9.31 | 25.3 | 0.1375 | | 12.75 | 0.005 | 1 | |
| | 1.961405604 | −16.17 | 25.2 | 0.2375 | | 12.75 | 0.005 | 1 | |
| | 1.973542883 | −23.05 | 25.1 | 0.3375 | | 12.75 | 0.005 | 1 | |
| | 2.005048715 | 4.36 | 25.4375 | 0 | | 12.75 | 0.010 | 1 | |
| ✓ | 2.002092869 | 1.81 | 25.4 | 0.0375 | | 12.75 | 0.010 | 1 | |
| | 1.994210613 | −5.02 | 25.3 | 0.1375 | | 12.75 | 0.010 | 1 | |
| | 1.986328358 | −11.88 | 25.2 | 0.2375 | | 12.75 | 0.010 | 1 | |
| | 1.978446103 | −18.76 | 25.1 | 0.3375 | | 12.75 | 0.010 | 1 | |
| | 2.010005579 | 8.64 | 25.4375 | 0 | | 12.75 | 0.015 | 1 | |
| | 2.007042426 | 6.09 | 25.4 | 0.0375 | | 12.75 | 0.015 | 1 | |
| ✓ | 1.999140684 | −0.74 | 25.3 | 0.1375 | | 12.75 | 0.015 | 1 | |
| | 1.991238942 | −7.60 | 25.2 | 0.2375 | | 12.75 | 0.015 | 1 | |
| | 1.983337201 | −14.48 | 25.1 | 0.3375 | | 12.75 | 0.015 | 1 | |
| | 2.01495025 | | 12.89 | 25.4375 | 0 | | 12.75 | 0.020 | 1 |
| | 2.011979807 | 10.34 | 25.4 | 0.0375 | | 12.75 | 0.020 | 1 | |
| ✓ | 2.004058627 | 3.51 | 25.3 | 0.1375 | | 12.75 | 0.020 | 1 | |
| | 1.99613707 | −3.35 | 25.2 | 0.2375 | | 12.75 | 0.020 | 1 | |
| | 1.988216266 | −10.23 | 25.1 | 0.3375 | | 12.75 | 0.020 | 1 | |
| | 2.019882816 | 17.13 | 25.4375 | 0 | | 12.75 | 0.025 | 1 | |
| | 2.016905102 | 14.57 | 25.4 | 0.0375 | | 12.75 | 0.025 | 1 | |
| | 2.006964531 | 7.74 | 25.3 | 0.1375 | | 12.75 | 0.025 | 1 | |
| ✓ | 2.001023959 | 0.89 | 25.2 | 0.2375 | | 12.75 | 0.025 | 1 | |
| | 1.993083388 | −6.00 | 25.1 | 0.3375 | | 12.75 | 0.025 | 1 | |
| | 2.024803366 | 21.34 | 25.4375 | 0 | | 12.75 | 0.030 | 1 | |
| | 2.021818398 | 18.78 | 25.4 | 0.0375 | | 12.75 | 0.030 | 1 | |
| | 2.013858483 | 11.95 | 25.3 | 0.1375 | | 12.75 | 0.030 | 1 | |
| | 2.005898568 | 5.10 | 25.2 | 0.2375 | | 12.75 | 0.030 | 1 | |
| ✓ | 1.997938653 | −1.79 | 25.1 | 0.3375 | | 12.75 | 0.030 | 1 | |

| | | | | extreme | | |
|---|---|---|---|---|---|---|
| | | | | stretch | | |
| 2.185520401 | 153.57 | 25.4375 | 0 | 12.75 | 0.200 | 1 |
| 2.162298504 | 151.02 | 25.4 | 0.0375 | 12.75 | 0.200 | 1 |
| 2.173706777 | 144.19 | 25.3 | 0.1375 | 12.75 | 0.200 | 1 |
| 2.165115051 | 137.33 | 25.2 | 0.2375 | 12.75 | 0.200 | 1 |
| 2.156523324 | 130.45 | 25.1 | 0.3375 | 12.75 | 0.200 | 1 |

Mechanical Impedance Matching Inline Transducer

See FIGS. 27 and 28.

Mechanical coupling is necessary when reducing frequencies from a musical instrument. The coupling between the bridge and the top of the instrument body is crucial for accurate frequency response and reproduction. The present invention considers a new methodology for constructing an inline transducer with improvement in mechanical coupling.

Force transducers require differential displacement in order to produce a signal. The existing piezo transducers do not allow enough mechanical displacement for accurate transduction. It is the assertion of this invention to allow for an instruments top and bridge displacement to be mechanically coupled to the transducer with little or no loss to the mechanical displacement.

Transducers, sensors and/or excitors, are placed within the force chain of the instrument. The placement can be under the sting's witness point, bridge, nut, fingerboard, within the neck and within the body.

The transducer is configured to provide and optimum mechanical impedance by the choice of structure and materials. The optimum tuning is via the compliant materials that the transducer materials are embedded within. The laminate structure can be cylindrical or rectangular cross-section. The piezoelectric or piezo-magnetic materials are fibers laid within the laminate comprised of the witness point, bridge, body or neck. The ratio of the volume of the compliant materials and supporting structure to active piezo fibers determine the optimum electrical output of the sensor, excitation impedance, and mechanical sound quality.

The standard use of braded copper or braided stainless steel for the shielding of unwanted electro static energy from entering the signal horizon of the transducer. The stiffness of these material hampers the ability of the transducer to mechanically couple with the displacement of the instruments top. Additionally the constant string pressure pulling against the bridge asserted by the strings can change the shape of the top of most acoustic instruments. The string saddle which is positioned between the strings vibrational force and the transducer has little ability to keep even coupled pressure on the transducer if the instrument tops shape bows or curves more than the saddles ability to follow the same bow or curve. A sensor is therefore needed that can retain mechanical coupling whether the top is curved or not and also move freely with the displacement modes of the vibrating instruments top, strings and saddle.

In the current invention PZT fibers are used to form a cylindrical shape around a tube of compliant material such as plastic with multiple lumen holes in various shapes extruded in the tube longitudinally. These holes allow for a spring action in the tube to accommodate the changing shapes required by the mechanical and physical coupling of the saddle and the instruments top or bridge. In a further variation the PZT fibers are placed on a substrate which is folded back and forth into layers with a flexible material between the layers. The flexible material can also have lumen holes throughout designed with the correct amount of tensional force to allow for the correct displacement and mechanical coupling. Additionally the material can be physically altered in it shape to account for the different pressures and displacement associated with the different string tensions.

An additional variation calls for the musical instruments top to be coated, embedded, or integrated with the PZT fibers, with the above mentioned correct amount of tensional force to allow for the correct displacement and mechanical coupling.

The piezo fibers can be arranged in several ways. The fibers can be laid across the direction of the strings parallel to the direction of the bridge, or short fibers can laid parallel to or perpendicular to the direction of the strings. They can be laid into the surface layers of the body, fingerboard and neck.

Embedded piezoelectric materials are comprised of but not limited to PZT, Tournaline, PVDF, and Quartz, biopolymers including collagen, polypeptides like polymethylglutamate and poly-benzyl-L-glutamate oriented films of DNA, poly-lactic acid, Chitosan, and Keratin, and Chitin, a polysaccharide glucose derivative (N-acetyl-d-glucosamine).

The optimum combination of choice of piezo-electric or piezo-magnetic material, fiber material, size and orientation, intra-embedded material, and supporting structure shape and materials determine high performance charge and/or voltage sensitivity and achieve signal to noise ratio and bandwidth.

Adjustable Truss Rod

The adjustable truss rod is comprised of two sections joined in the middle by a adjusting mechanism. Adjustable truss tensions provides for te optimum mechanical impedance of the truss rod which is an important link in the complex dynamic force chain.

The adjusting mechanism is comprised of a pair of wedge blocks linked by a threaded rod or screw.

See FIG. 22

Assumption: Truss Rod is embedded in Stringed instrument neck and has pressure due to exact all around surface fit of wood Slot and Fingerboard

Truss Rod Wedge Block Applies pressure to separate upper and lower a Truss Rods

The Resultant gap or Separation of the upper and lower rods causes the rods to bow. An arc apex is created depending upon where pressure is applied over the length of the rods. The current design calls for pressure to be applied at one or several points along the rods length in order to effect changes in the truss rods arc apex.

Thereby changing the Arc Apex in the Normally utilized Standard Over-under Truss Rod Design to affect changes in pressure with in the stringed musical instruments neck.

See FIGS. 23a-d Adjustable Truss Rod Tension Units

This design provides for adjustments in the tension of a truss rod within a stringed musical instrument neck. The truss rod is made of 2 rods with provisions to be adjusted from the side of the neck at various points. The circular Truss rods have “V” shaped wedges positioned between the upper and lower rods. Provision is made for the “V” shaped end of the wedge to be draw towards its wedge counterpart by a threaded screw that passes through the inserts to draw them together. One section of the screw has reversed threads, as does its corresponding inserts, so as to provide a squeezing or tension in action against the individual sides of the truss rods. This embodiment provides for adjustment perpendicular to force the truss rods to spread only from each other thus increasing attention at that point within the musical instruments neck. This wedging action is provided for and various points along a light of the neck. In another embodiment the spreading wedges are replaced by round rods or ball bearing shaped inserts.

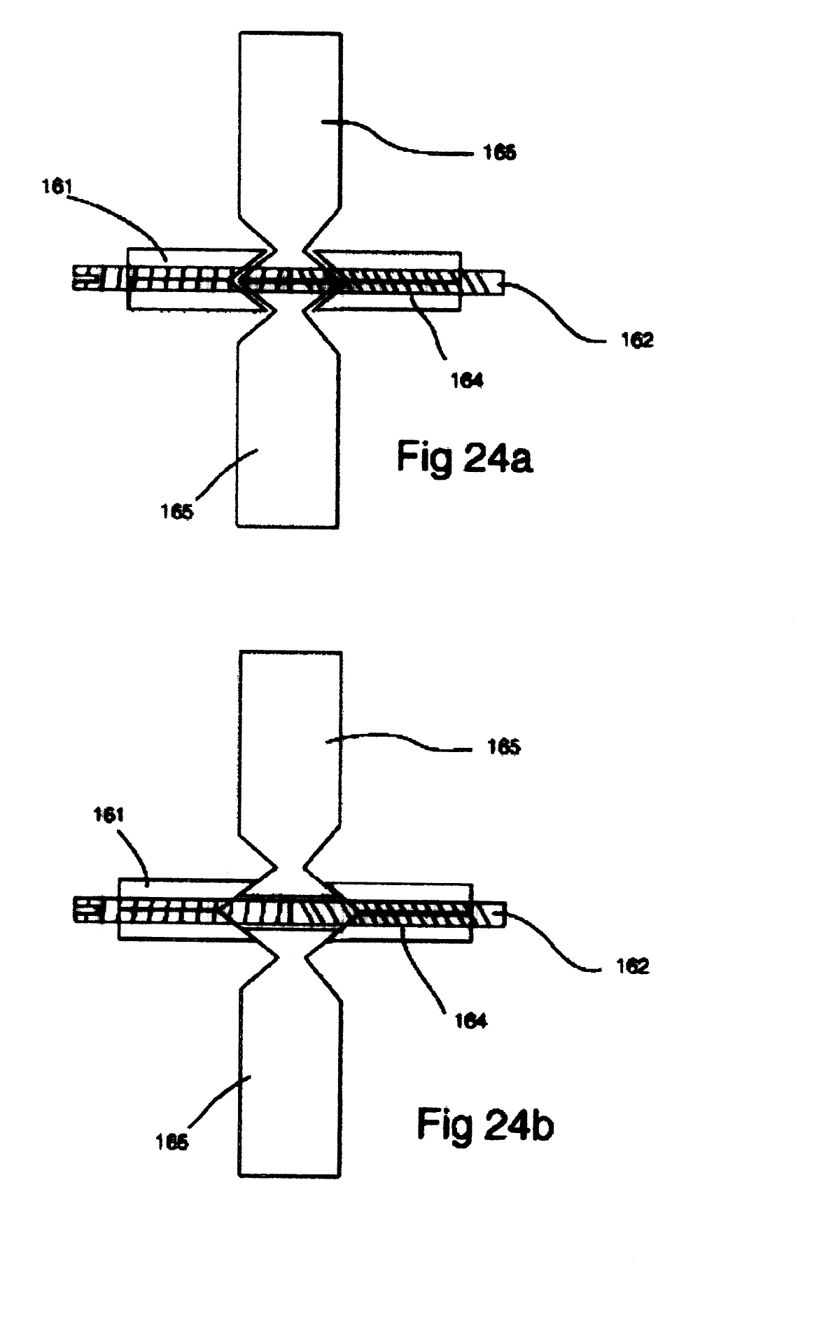

See FIGS. 24a-24b Adjustable Truss Rod Tension Units

This design provides for adjustments to the tension of a truss rod within a stringed musical instrument neck. The truss rod is made in several sections with provisions to be adjusted from the side of the neck at various points. The circular Truss rod sections have been machined a “V” shaped wedge. Provision is made for the “V” shaped end of the truss rod to be draw toward its sectional counterpart by conforming inserts on two sides of the truss rod a threaded screw passes through the inserts to draw them together. One section of the screw has reversed threads, as does its corresponding inserts, so as to provide a squeezing or tension in action against the individual ends' of the truss rod sections. This embodiment provides for adjustment perpendicular to the force of the truss rod within the musical instruments neck.

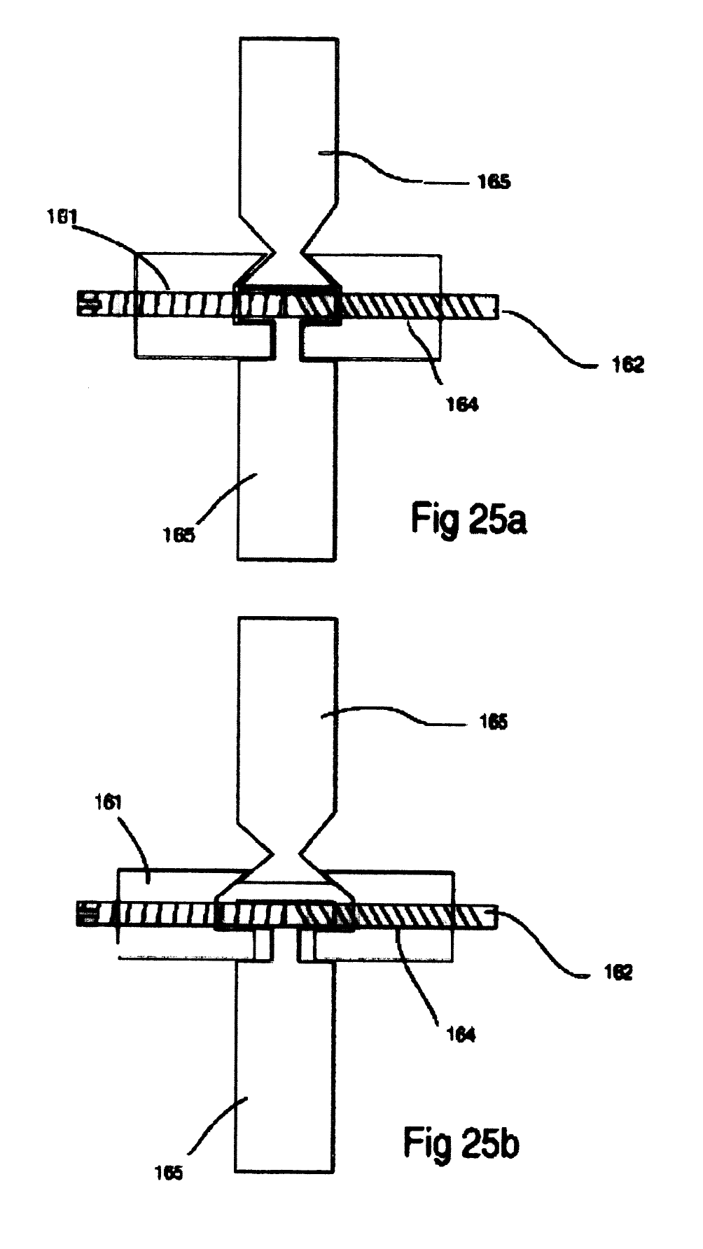

See FIGS. 25a-25b Adjustable Truss Rod Tension Units

This design provides for adjustments to the tension of a truss rod within a stringed musical instrument neck. The truss rod is made in several sections with provisions to be adjusted from the side of the neck at various points. The circular Truss rod sections have been machined a “V” shaped wedge on one side and a “T” shaped groove on the other. Provision is made for the “V” shaped end of the truss rod to be draw toward its sectional “T” shaped counterpart by conforming inserts on two sides of the truss rod. A threaded screw passes through the inserts to draw them together. One section of the screw has reversed threads, as does its corresponding inserts, so as to provide a squeezing or tension in action against the individual ends' of the truss rod sections. This embodiment provides for adjustment perpendicular to the force of the truss rod within the musical instruments neck.

High Energy Resilient Tremolo Bearing

See FIG. 26

Low friction material is installed under the tremolo pivot point are provided to prevent rubbing on the finished surface of the instrument. The low friction material is embedded in the bridge plate or into an intermediary plate so the low friction pivot inserts bridge between the instrument body and the tremolo bridge plate. These components are specifically designed to lower the friction between parts to allow the tremolo to return to it balanced centered tensional position in order to reach an acceptable amount of intonation while increasing the sustain and tonal response of the instrument.

The tremolo bearing is comprised of very smooth, hard, and energy resilant materials including but not limited to Saphire, Ruby, Alumina, BN, SiC, “diamond” coatings

What is claimed is: APPARATUS

1 An intonation correcting adjustable witness point comprising a manually height adjustable string bearing;
a mechanism which moves the string bearings axial position automatically and synchronously to the height adjustment; where the axial movement provided achieves proper intonation.

2 The intonation correcting adjustable witness point in claim 1, further comprising a cylindrical height/length adjustment barrel, rotating on it's circumferential surface or outer bearing surface within an inner bearing surface retaining assembly, consisting of
a. worm screw and a pinion shaft utilized to rotate cylindrical height/length adjuster;
b. a set screw and a notched cylinder or rod utilized to rotate cylindrical height/length adjuster;
c. a wedge placed in order to rotate cylindrical height/length adjuster
d. a cylindrical height/length adjuster that during rotation puts pressure on a plate in order that it moves in one or more directions.
e. A longitudinally cut rod which when depressed on one radial side of it's diameter rotates and puts pressure on a plate in order that it moves in one or more directions.
f. A longitudinally cut rod with a post in the center diameter; which rotates with pressure applied to the post and in turn puts pressure on a plate in order that it moves in one or more directions.

3 The intonation correcting adjustable witness point in claim 1, further comprising a nut.

4 The intonation correcting adjustable witness point in claim 1, wherein the witness point is a bridge

5 The intonation correcting adjustable witness point in claim 1, wherein the witness point has a more acute break angle on the high pitch string and less acute break angle on the low pitch string.

6 The intonation correcting adjustable witness point in claim 1, wherein the witness point and string bearing are comprised of but not limited to crystalline ruby and sapphire or quartz, or the group of aluminum oxides, silicon carbide, ceramics or piezoelectric materials, graphite composites or the group of metals, beryllium bearing amorphous metallic alloys, and other suitable materials, pure or alloys thereof.

7 The intonation correcting adjustable witness point in claim 1, a fret bearing comprising a hard and high energy resiliency material

8 The intonation correcting adjustable witness point in claim 1, wherein a inner bearing surface retaining assembly is attached to an apparatus that provides additional intonation adjustment while providing for optimum dynamic force chain. Comprising:
a. A apparatus for mounting a cylindrical height/length adjustment barrel, rotating on it's circumferential surface or outer bearing surface within an inner bearing surface of claim 1, to the existing saddle slot on an acoustic or classical format bridge assembly.
b. The intonation correcting adjustable witness point in claim 1, provides for a bracket for further effecting a longitudinal adjustment of the string relative to the bridge attached to the instrument body. The bracket consisting of a material with one end fitted vertically to the saddle slot in the acoustic guitar bridge and the other end running parallel to the top of the instrument.
c. In one embodiment a slotted bracket is fixed into the bridge. The bracket is slotted for the retention of the a witness point assembly. The witness point assembly is mounted to the slotted bracket with a screw. A retaining hole extending perpendicularly in alignment with the string in one end of the bracket provides a receptacle for the screw. An adjustment screw extending from one end of the bracket to the witness point assembly for the purpose of moving the witness point assembly parallel to the string a alignment. The bottom of the witness point assembly moves across the brackets bearing surface.

9 The intonation correcting adjustable witness point in claim 1, wherein a nut assembly for stringed instruments for fastening the strings of the instrument to an upper part of the neck of the instrument, the nut comprising of a solid base plate, a bearing surfaced cylindrical ring for each string mounted in a internally Threaded Nut Saddle assembly, the bearing surfaced cylindrical ring is mounted within a Hex Head Barrel Screw being rotatable for effecting a longitudinal adjustment of the string relative to the bridge attached to the instrument body, the a bearing surfaced cylindrical ring having a bearing surface axis extending perpendicularly and parallel to a string axis, the bearing surface defining a string having an axis and extending perpendicularly to the bearing surface axis, the Hex Head Barrel Screw defining a retaining hole positioned in the base body, the retaining hole extending perpendicularly in alignment with the string, the bearing surface having a hole in alignment with the string, the bearing surface providing intonation adjustment of the string, by rotation in it's radial direction with respect to the threads provided within the Threaded Nut Saddle and threads provided on the external surface of the Hex Head Barrel Screw.

10 The intonation correcting adjustable witness point in claim 1, wherein that the Threaded Nut Saddle assemblies are mounted on a base place using a tie rod and the necessary corresponding hole for said tie rod by which a pivot is created for the purpose of adjusting the location of the threaded nut saddle position sliding longitudinally upon the tie rod, which is designated on this design as width adjustment, and additionally, a pivot is created for the purpose of adjusting the location of the threaded nut saddle at it's opposite end from the pivot by which a height adjustment is created using a screw threaded through the Threaded Nut Saddle assembly from the top of one end to the bottom of the same end and touching the solid base plate.

11 The intonation correcting adjustable witness point in claim 1, wherein the Threaded Nut Saddle assemblies are mounted on a base plate using individual tie rods and the necessary corresponding holes and receptacles for said tie rods by which pivots are created for each nut saddle assembly.

12 An inline vibration sensor within a witness point structure comprising a composite or laminate structure;
a mechanical impedance is tuned to provide optimum dynamic force chain complex impedance;
b ratio of mechanical impedance to charge or voltage sensitivity is tuned for optimum signal to noise ratio and bandwidth.

13 The inline vibration sensor in claim 12, wherein embedded piezoelectric materials are comprised of but not limited to PZT, Tournaline, PVDF, and Quartz, biopolymers including collagen, polypeptides like poly-methylglutamate and poly-benzyl-L-glutamate oriented films of DNA, poly-lactic acid, Chitosan, and Keratin, and Chitin, a polysaccharide glucose derivative (N-acetyl-d-glucosamine).

14 The inline vibration sensor in claim 12, wherein the stringed instrument is in part or in its entirety or within various structural members is comprised of piezoelectric composite or laminate material where the embedded piezoelectric materials or oriented in one or more directions. The piezoelectric fibers are laminated onto the surface of the instrument as an integral part of the surface is provided in one embodiment

15 An adjustable truss rod comprising:
a wedge mechanism that when compressed pulls a right and left section truss rods tighter or looser, increasing or decreasing tension overall and at determined point(s)

16 An adjustable truss rod in claim 15, wherein
a pair of wedge blocks linked by a threaded rod or screw.

17 A tremolo bearing comprising a hard and high energy resiliency material.
METHODS

18 A method of intonation when adjusting the axial position of the string bearing when the height position is changed, comprising the steps of:
providing the sensing of the height change;
providing the computation of the axial position for accurate intonation of the string;
providing the movement of the axial position;
providing accurate intonation of the string.

19 The method of claim 18, wherein said step of the computation of the axial position for accurate intonation of the string is:
a gearing ratio based
b CPU processing based.
C tension torque based

20 The method of claim 18, wherein said witness points be positioned at the locations of, but not limited to, the nut, bridge, tremolo, finger board, neck, and body

21 A method of fabricating inline vibration sensor, comprising the steps of:
providing a piezoelectric composite or laminate;
providing a mechanical impedance of the composite tuned to optimum the force chain;
providing the fraction of the composite as piezoelectric material to adjust the charge or voltage sensitivity;
